(19) United States
(12) Patent Application Publication
(10) Pub. No.: US 2014/0049830 A1
(43) Pub. Date: Feb. 20, 2014

(54) Arrangement For Shaping Laser Radiation

(71) Applicant: LIMO Patentverwaltung GmbH & Co. KG, Dortmund (DE)

(72) Inventor: Detlef STOEHR, Castrop-Rauxel (DE)

(73) Assignee: LIMO Patentverwaltung GmbH & Co. KG, Dortmund (DE)

(21) Appl. No.: 13/966,099

(22) Filed: Aug. 13, 2013

(30) Foreign Application Priority Data
Aug. 14, 2012 (DE) 10 2012 107 456.9

(51) Int. Cl. G02B 27/09

(52) U.S. Cl. CPC G02B 27/0983
USPC 359/627

(57) ABSTRACT

An arrangement for shaping laser radiation with mutually spaced-apart parallel sub-beams in a first direction perpendicular to a propagation direction of laser radiation, including a first substrate with several reflective surfaces on which the sub-beams reflects, and a second substrate with several reflective surfaces and being offset relative to the first substrate, so that the sub-beams reflected by the reflective surfaces of the first substrate reflects by the reflective surfaces of the second substrate, wherein the reflective surfaces of the first substrate and the reflective surfaces of the second substrate are arranged and configured such that the sub-beams of the laser radiation to be shaped can be reflected in such a way that they have after the reflection on the reflective surfaces of the second substrate in the first direction a smaller spacing from one another than before the reflection on the reflective surfaces of the first substrate.

This application claims priority to DE 10 2012 107 456.9 filed on Aug. 14, 2012.

### BACKGROUND OF THE INVENTION

The present invention relates to an arrangement for shaping laser radiation.

Definition:

The terms light or illumination or laser radiation are not intended to be limited to the visible spectral wavelength range. Rather, the term light or illumination or laser radiation is used in the context of this application for electromagnetic radiation in the entire wavelength range from FIR to XUV. In the propagation direction of the light, the mean propagation direction of light indicates, particularly when this is not a plane wave, or is at least partially convergent or divergent. Light beam, sub-beam, or ray refers, unless expressly stated otherwise, not to an idealized beam of the geometrical optics, but to a real light beam such as a laser beam having a Gaussian profile, which does not have an infinitesimally small beam cross-section, but rather an extended beam cross-section.

Laser diode bars have a plurality of emitters that are arranged spaced from one another in the so-called slow axis. The slow axis is a first direction, in which the active layer of the semiconductor diode extends, whereas the fast axis is the (second) direction perpendicular thereto. For example, each of the emitters has a length of about 150 μm in the slow axis, whereas the mutual spacing between two adjacent emitters in this direction is approximately 400 μm. As a result, dark areas exist between the sub-beams originating from the individual emitters, which have an adverse effect on the so-called “brightness” (specific intensity) of the laser radiation.

EP 2073051 A2 discloses a device for shaping laser radiation having sub-beams that are spaced-apart from each other in a first direction (x-direction) perpendicular to the propagation direction (z-direction) of the laser beam, in particular for shaping laser radiation originating from a laser diode bar, having a first refractive interface which can deflect at least a plurality of sub-beams of the laser radiation to be shaped in different ways so that they are at least partially more convergent relative to each other after passing through the first interface than before passing through the first interface, and a second refractive interface. through which the laser beam can pass after having passed through first interface, wherein the second interface can deflect at least some of the sub-beams so as to reduce their convergence. Such an arrangement allows a reduction of the dark area between the individual sub-beams by reducing or eliminating the spacing between the sub-beams in the first direction, so that the attainable “brightness” can be increased. It has been observed that such an arrangement often does not provide adequate efficiency, since a large part of the optical power is in the side lobes, which are eliminated in the course of the beam path with apertures, and their thermal energy must be dissipated.

The sub-beams emitted from the emitters of a laser diode bar can also be moved closer by using staircase mirrors in the optical path. However, this approach requires a deflection of the individual sub-beams by 90°. An additional deflection of the sub-beams by 90° is required to maintain the original propagation direction of the laser radiation. It has been found that the achievable brightness is frequently insufficient even with this approach.

### BRIEF SUMMARY OF THE INVENTION

This is the starting point for the present invention, which has as an object to provide an arrangement for shaping laser radiation which is configured to shape laser radiation originating from a laser light source, in particular from a laser diode bar having a plurality of emitters, so that the laser radiation has greater brightness in a work area.

This is achieved according to the invention with an arrangement having the features of claim 1. The dependent claims relate to advantageous embodiments of the present invention.

An inventive arrangement for shaping laser radiation having mutually spaced-apart parallel sub-beams in a first direction (x-direction) perpendicular to a propagation direction (z-direction) of the laser radiation in particular for shaping laser radiation emitted from a laser diode bar, includes
a first substrate having a plurality of reflective surfaces, on which the sub-beams can be reflected, and
a second substrate having a plurality of reflective surfaces, which is arranged with an offset relative to the first substrate such that the sub-beams reflected by the reflective surfaces of the first substrate can be reflected by the reflective surfaces of the second substrate,
   wherein the reflective surfaces of the first substrate and the reflective surfaces of the second substrate are arranged and constructed so that the sub-beams of the laser radiation to be formed can be reflected such that they have, after reflection on the reflective surfaces of the second substrate, a smaller mutual spacing in the first direction than before the reflection on the reflective surfaces of the first substrate. The dark area between the sub-beams can thus be reduced by reducing or eliminating the spacing between the sub-beams in the first direction (x-direction), so that the attainable brightness approaches more closely the physical limit. Advantageously, a higher overall brightness can thus be achieved. The arrangement of the invention can be used, for example, with laser light sources where individual sub-beams must be geometrically combined for subsequent coupling into, for example, an optical fiber or for compact superposition of individual sub-beams by geometric coupling and/or polarization coupling and/or wavelength coupling to further increase the optical power.

In a preferred embodiment, the reflective surfaces of the first substrate may be formed so as to be able to differently reflect at least a plurality of sub-beams of the laser radiation to be formed so that they propagate after reflection at least partially more convergent relative to each other than before the reflection on the reflective surfaces of the first substrate. Specifically, the reflection angles of the sub-beams reflected on the individual reflective surfaces of the second substrate may differ in such a way that all the sub-beams propagate parallel to each other after reflection on the reflective surfaces of the second substrate, wherein in particular the distance between the sub-beams has been reduced in the first direction or, even more advantageously, has been substantially eliminated.

In a particularly preferred embodiment, the reflective surfaces of the second substrate may be formed so as to be able to reflect at least some of the sub-beams in such a way that the convergence of the sub-beams is reduced so that they propagate parallel to one another with deviations of ±10%, preferably ±5%, in particular ±1%. In this way, the sub-beams propagate again (at least almost) parallel to one another after reflection on the second substrate—and, preferably, in the original propagation direction (z).

In an advantageous embodiment, the reflective surfaces of the first and/or the second substrate may be inclined relative to each other, wherein in particular at least one of the sub-beams can be reflected by each of the reflective surfaces. Individual sub-beams, in particular all sub-beams, are then reflected on the reflective surfaces of the first and second substrates with mutually different angles. For example, the reflection angles of the sub-beams reflected on the individual reflective surfaces of the first substrate may be different such that all sub-beams are directed after the reflection onto a “virtual” point, which is located behind the second substrate in the propagation direction of sub-beams reflected on the first substrate.

In a particularly advantageous embodiment, the mutually inclined reflective surfaces of the first substrate and/or of the second substrate may be at least partially planar. This simplifies the manufacture of the reflective surfaces. Preferably, the reflective surfaces of the first substrate and/or of the second substrate may adjoin each other, thereby further simplifying the manufacture of the reflective surfaces.

In a particularly preferred embodiment of the invention, the mutually adjoining reflective surfaces of the first substrate may form concave edges and/or the mutually adjoining reflective surfaces of the second substrate may form convex edges. A convex edge is defined such that the two adjacent reflective surfaces are directed away from an observer. A concave edge is defined such that adjacent reflective surfaces are directed toward the observer. The reflection angles of the reflective surfaces of the first and second substrates then advantageously match each other. In particular, the mutually adjoining reflective surfaces of the first substrate may at least partially enclose with each other an angle between 150° and <180°, in particular an angle between 165° and <180°, preferably an angle between 175° and 179°. Accordingly, the mutually adjoining surfaces of the second substrate may at least partially enclose with each other an angle between >180° and 210°, in particular an angle between >180° and 195°, preferably an angle between 181° and 185°.

Preferably, the reflective surfaces of the second substrate may be dimensioned and arranged such that each of the sub-beams reflected on the reflective surfaces of the first substrate can be incident on and reflected by one of the reflective surfaces of the second substrate.

In an advantageous embodiment, the arrangement may include collimating means configured to at least partially collimate the laser radiation with respect to the first direction and/or with respect to a second direction that is perpendicular to the first direction and to the propagation direction of the laser radiation, wherein in particular the collimating means are arranged in front of the first substrate in the propagation direction of the laser radiation.

Furthermore, slow axis collimating means may be arranged behind the second substrate in the beam propagation direction. These can advantageously further reduce the remaining divergence of the sub-beams in y-direction.

### BRIEF DESCRIPTION OF THE DRAWINGS

Additional features and advantages of the present invention will become apparent from the following description of a preferred exemplary embodiment with reference to the appended drawings, which show in

FIG. 1 a perspective view of an arrangement for shaping laser radiation which is constructed according to a preferred exemplary embodiment of the present invention,

FIG. 2 a plan view of the arrangement of FIG. 1, and

FIG. 3 a side view of the arrangement shown in FIGS. 1 and 2

### DETAILED DESCRIPTION OF THE INVENTION

To simplify the following description, Cartesian coordinate systems, which define the mutually orthogonal x-, y- and z-directions, are shown in all Figures.

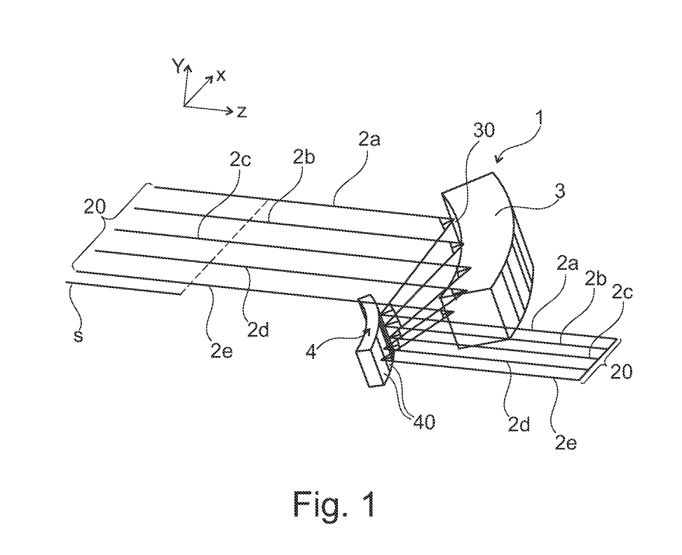

In FIGS. 1-3, reference numeral 2a-2e indicate several (five exemplary) sub-beams that can be emitted from particular emitters of a laser diode bar (not explicitly shown here for sake of simplicity) and form a laser beam (laser radiation) 20. The propagation direction, in which the sub-beams 2a-2e propagate, is here the z-direction. The individual emitters of such laser diode bar are spaced from one another in the so-called slow axis (in this case in the x-direction). Typically, each emitter of such a laser diode bar may have a length of about 150 μm in the slow axis, wherein the spacing between two adjacent emitters in this direction is approximately 400 μm. The individual emitters thus emit sub-beams 2a-2e of the laser radiation of the laser diode bar.

The arrangement shown in FIG. 1 may include a fast-axis collimation lens (not explicitly shown) arranged after the emitters of the laser diode bar in the propagation direction (z-direction) which is configured so as to collimate the individual sub-beams 2a-2e in the so-called fast axis (in y-direction in the Figures). Additionally, a beam transformation device, which is configured to rotate each one of the different sub-beams 2a-2e by 90° with respect to the propagation direction (z-direction), may be arranged after the fast-axis collimation lens in the propagation direction (z-direction). This interchanges the divergence of the sub-beams 2a-2e in the fast axis with that in the slow axis, so that the sub-beams 2a-2e are collimated in the slow axis (in the Figures in the x—direction) after passing through the beam transformation device. Such beam transformation devices are in principle known in the art and have, for example, cylindrical lenses arranged side-by-side in the x-direction, with their cylinder axes aligned at an angle of with respect to the x-direction in the x-y plane. The resulting laser beam 20 emitted by the laser light source has a width B1, wherein adjacent sub-beams 2a-2e have a mutual spacing A1 from one another which depends on the distances between the emitters of the laser diode bar.

Referring to FIGS. 1 to 3, an arrangement 1 for shaping laser radiation which is constructed according to a preferred embodiment of the present invention and on which the sub-beams 2a-2e collimated, for example in the manner described above, are incident, has a first substrate 3 and a second substrate 4 in the propagation direction (z), which have a height offset in the y-direction and are mutually spaced from each other in z-direction. The second substrate 4 is arranged in front of the first substrate 3 in z-direction, and is offset downwards in the y-direction relative to the first substrate 3 and relative to the sub-beams 20 incident on the first substrate 3.

The first substrate 3 has a plurality of reflective surfaces 30 on its side facing the sub-beams 2a-2e, by which the sub-beams 2a-2e can be reflected and thus undergo a first reflection. The second substrate 4 also has a plurality of reflective surfaces 40 on its side facing the first substrate 3, by which the sub-beams 2a-2e reflected on the reflective surfaces 30 of the first substrate 3 can again be reflected and thereby undergo a second reflection. The individual reflective surfaces 30, 40 of the substrates 3, 4 have a planar shape, wherein adjacent, adjoining reflective surfaces 30, 40 are inclined with respect to one another.

Adjacent reflective surfaces 30 of the first substrate 3 each include with each other an angle of <180°. Because the angles between adjacent reflective surfaces 30 of the first substrate 3 are <180°, these surfaces 30 form an “inward” facing reflective outer contour on the side facing the sub-beams 2a-2e, on which the sub-beams 2a-2e can be reflected in the direction of the second substrate 4 (i.e. opposite to the original propagation direction and downwardly in the y-direction). Adjacent reflective surfaces 40 of the second substrate 4 enclose with each other an angle of >180″. Because the angles between adjacent reflective surfaces 40 of the second substrate 4 are >180°, they form an “outwardly” facing reflective outer contour on the side facing the sub-beams 2a-2e reflected from the first substrate 3, on which the sub-beams 2a-2e can be reflected back into the original propagation direction (z-direction). The adjoining reflective surfaces 30 of the first substrate 3 form so-called concave edges and adjoining reflective surfaces 40 of the second substrate 4 form so-called convex edges. A convex edge is defined such that two adjoining reflective surfaces 40 of the second substrate 4 are facing away from an observer. In contrast, a concave edge is defined so that the adjoining reflective surfaces 30 of the first substrate 3 are facing the observer. The reflection angles of the reflective surfaces 30, 40 of the first and second substrates 3, 4 then advantageously match each other. In particular, the mutually adjoining reflective surfaces 30 of the first substrate may at least partially enclose with each other an angle between 150° and <180°, in particular an angle between 165° and <180°, preferably an angle between 175° and 179′. Accordingly, the adjoining reflective surfaces 40 of the second substrate 4 may be at least partially enclose with one another an angle between >180° and 210°, in particular an angle between 180° and 195°, preferably an angle between 181° and 185°.

Thus, the sub-beams 2a-2e incident on the reflective surfaces 30 of the first substrate 3 are reflected by the reflective surfaces 30 (opposite to the original propagation direction and downwardly in the y-direction) so that they are incident on and reflected by the reflective surfaces 40 of the second substrate 4 and subsequently propagate again in the original propagation direction (z-direction). Due to this double reflection on the two mutually offset substrates 3, 4 constructed in the manner described above, the sub-beams 2a-2e experience a height offset h in the y-direction. Adjacent sub-beams 2a-2e have a spacing A2<A1 after reflection on the second substrate 4 and propagate (at least substantially) parallel to each other. The width of the resulting laser beam 2′ composed of the individual sub-beams 2a-2e is then B2<B1, so that it has almost the same optical power, albeit with a smaller beam width.

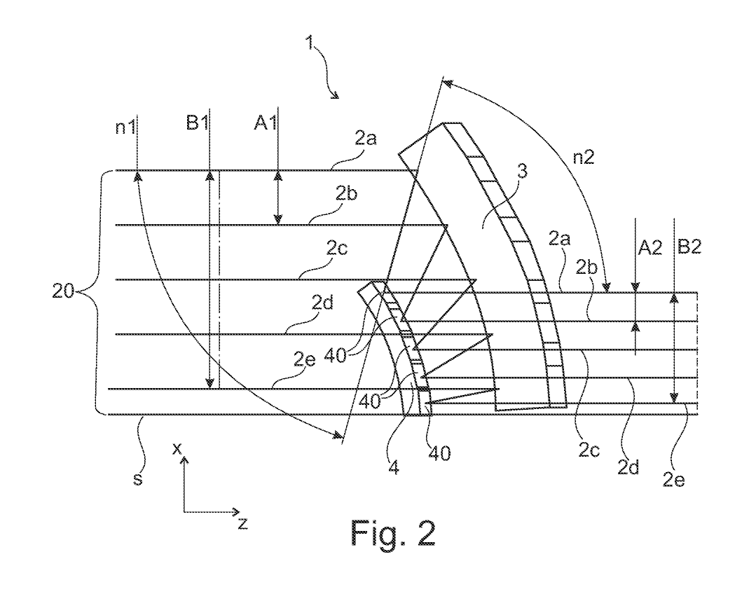

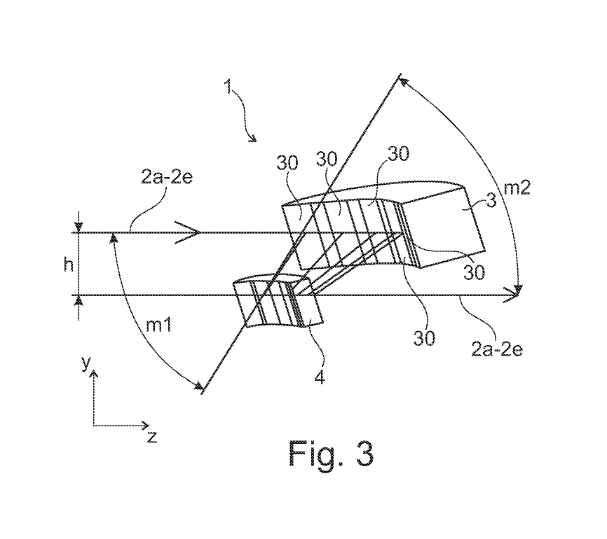

Due to the reflections on the reflective surfaces 30 of the first substrate 3, the sub-beams 2a-2e experience in the illustrated arrangement 1a deflection by an angle m1 in the vertical direction (see FIG. 3) and a deflection by n1 in the horizontal direction (see FIG. 2). Due to the reflections on the reflective surfaces 40 of the second substrate 4, the sub-beams 2a-2e experience in the illustrated arrangement 1a deflection by m2 in the vertical direction (see FIG. 3) and a deflection by n2 in the horizontal direction (see FIG. 2). In other words, the individual sub-beams 2a-2e are deflected in two angular planes at each reflection on the reflective surfaces 30, 40 of the first and second substrates 3, 4. The reflective surfaces 30, 40 are herein dimensioned and arranged such that always one of the sub-beams 2a-2e is incident on one of the reflective surfaces 30, 40.

As shown in particular in FIG. 2, the sub-beams 2a 2e are reflected in the vertical direction at different angles n1, n2 on the reflective surfaces 30 of the first substrate 3 and on the reflective surfaces 40 of the second substrate 4, wherein n1 (sub-beam 2a)>n1 (sub-beam 2b)>n1 (sub-beam 2c)>n1 (sub-beam 2d)>n1 (sub-beam 2e) as well as n2 (sub-beam 2a)>n2 (sub-beam 2b)>n2 (sub-beam 2c)>n2 (sub-beam 2d)>n2 (sub-beam 2e). Likewise, the following applies to the reflections of the sub-beams 2a-2e in the horizontal direction: m1 (sub-beam 2a)>m1 (sub-beam 2b)>m1 (sub-beam 2c)>m1 (sub-beam 2d)>m1 (sub-beam 2e) as well as m2 (sub-beam 2a)>m2 (sub-beam 2b)>m2 (sub-beam 2c)>m2 (sub-beam 2d)>m2 (sub-beam 2e). In other words, the reflection angles n1, n2, m1, m2 gradually decrease from the first sub-beam 2a to the last sub-beam 2e. After reflection on the reflective surfaces 30 of the first substrate 3, the (initially parallel) sub-beams 2a-2e are then no longer parallel to each other, but propagate towards each other and are thus convergent. After reflection on the reflective surfaces 40 of the second substrate 4, the sub-beams 2a-2e are again more collimated and propagate again substantially parallel to each other (in the z-direction).

As can be inferred from the Figures, that the dark areas (i.e. the non-illuminated areas) between two adjacent sub-beams 2a-2e before the successive reflections on the reflective surfaces 30, 40 of the two substrates 3, 4 in the x-direction are significantly broader than the dark areas between the sub-beams 2a-2e after the reflections on the reflective surfaces 30, 40 of the two substrates 3, 4. Ideally, the dark regions between adjacent sub-beams 2a-2e are approximately zero after reflection on the reflective surfaces 30, 40 of the two substrates 3, 4 in the x-direction.

Slow-axis collimating means (not explicitly shown) may optionally be provided in the beam propagation direction after the two substrates 3, 4, which can further reduce the remaining difference of the sub-beams 2a-2e in y-direction,

The aforedescribed arrangement is suitable, for example, for use in laser light sources that require a geometric combination of the sub-beams 2a-2e, which can then be coupled, for example, into an optical fiber or which can be superimposed in a compact manner by geometric coupling and/or polarization coupling and/or wavelength coupling so as to hereby further increase the optical power.

The principle underlying the present invention was described in an example by using five sub-beams 2a-2e of a laser light source, in particular a laser diode bar with a corresponding number of emitters. The substrates 3, 4 can also be designed so as to be able to fulfill their aforedescribed function across the entire width of a laser beam 20 with more (or less) than five sub-beams 2a-2e. For example, for a larger beam width (for example, with ten sub-beams), two additional correspondingly shaped substrates may be arranged on the other side of a line S, which in this variant forms a center line or symmetry line, in a “right-hand variant” (the substrates 3, 4 form a “left-hand variant”, since they influence here the sub-beams 2a-2e propagating to the left of the line S, as viewed in the beam propagation direction).

1. An arrangement (1) for shaping laser radiation (20) which comprises mutually spaced-apart parallel sub-beams (2a-2e) in a first direction (x) perpendicular to a propagation direction (z) of the laser radiation (20), in particular for shaping laser radiation (20) emitted by a laser diode bar, comprising
a first substrate (3) having a plurality of reflective surfaces (30) on which the sub-beams (2a-2e) can be reflected, and
a second substrate (4) having a plurality of reflective surfaces (40) and being offset relative to the first substrate (3), so that the sub-beams (2a-2e) reflected by the reflective surfaces (30) of the first substrate (3) can be reflected by the reflective surfaces (40) of the second substrate (4),
wherein the reflective surfaces (30) of the first substrate (3) and the reflective surfaces (40) of the second substrate (4) are arranged and configured such that the sub-beams (2a-2e) of the laser radiation (20) to be shaped can be reflected in such a way that, after the reflection on the reflective surfaces (40) of the second substrate (4) in the first direction (x), they are parallel to one another and have in the first direction (x) a smaller spacing (A2) from one another than before the reflection on the reflective surfaces (30) of the first substrate (3).

2. The arrangement according to claim 1, wherein reflective surfaces (30) of the first substrate (3) are formed so that they can differently reflect at least a plurality of the sub-beams (2a-2e) of the laser radiation (20) to be shaped so that, they propagate after the reflection at least partially more convergent with respect to each other than before the reflection on the reflective surfaces (30) of the first substrate (3).

3. The arrangement according to claim 1, wherein the reflective surfaces (40) of the second substrate (4) are formed so that they can reflect at least some of the sub-beams (2a-2e) in such a way that the convergence of the sub-beams (2a-2e) is reduced so that they propagate parallel to one another with deviations of ±10%, preferably ±5%, in particular ±1%.

4. The arrangement (1) according to claim 1, wherein the reflective surfaces (30, 40) of the first and/or the second substrate (3, 4) are inclined with respect to one another, wherein in particular at least one of the sub-beams (2a-2e) can be reflected by each of the reflective surfaces (30, 40).

5. The arrangement (1) according to claim 4, wherein the mutually inclined reflective surfaces (30, 40) of the first substrate (3) and/or the second substrate (4) are at least partially planar.

6. The arrangement (1) according to claim 4, wherein the mutually inclined reflective surfaces (30, 40) of the first substrate (3) and/or of the second substrate (4) adjoin one another.

7. The arrangement (1) according to claim 6, wherein the mutually adjoining reflective surfaces (30) of the first substrate (3) form concave edges and/or that the mutually adjoining reflective surfaces (40) of the second substrate (4) form convex edges.

8. The arrangement according to claim 6, wherein the mutually adjoining reflective surfaces (30) of the first substrate (3) enclose at least partially with one another an angle between 150° and <180.

9. The arrangement according to claim 6, wherein the mutually adjoining reflective surfaces (40) of the second substrate (4) enclose at least partially with one another an angle between >180° and 210°.

10. The arrangement (1) according to claim 1, wherein the reflective surfaces (40) of the second substrate (4) are dimensioned and arranged such that a respective one of the sub-beams (2a-2e) reflected by the reflective surfaces (30) of the first substrate (3) is incident on and reflected by one of the reflective surfaces (40) of the second substrate (4).

11. The arrangement according to claim 1, wherein the arrangement (1) comprises collimating means, which at least partially collimates the laser radiation (20) with respect to the first direction and/or with respect to a second direction that is perpendicular to the first direction and to the propagation direction of the laser radiation (20), wherein in particular the collimating means are arranged before the first substrate (3) in the propagation direction of the laser radiation (20).

12. The arrangement according to claim 1, wherein slow-axis collimating means are arranged after the second substrate (4) in the beam propagation direction.

13. The arrangement according to claim 6, wherein the mutually adjoining reflective surfaces (30) of the first substrate (3) enclose at east partially with one another an angle between 165° and <180°.

14. The arrangement according to claim 6, wherein the mutually adjoining reflective surfaces (30) of the first substrate (3) enclose at least partially with one another an angle between 175° and 179°.

15. The arrangement according to claim 6, wherein the mutually adjoining reflective surfaces (40) of the second substrate (4) enclose at least partially with one another an angle between >180° and 195°.

16. The arrangement according to claim 6, wherein the mutually adjoining reflective surfaces (40) of the second substrate (4) enclose at least partially with one another an angle between 181° and 185°.
